(19) United States
(12) Patent Application Publication
(10) Pub. No.: US 2018/0354139 A1
(43) Pub. Date: Dec. 13, 2018

(54) System and method used by individuals to shop and pay in store via artificial intelligence robot

(71) Applicants: Kuo Guang Wang, San Jose, CA (US); Li Li Tay, San Jose, CA (US)

(72) Inventors: Kuo Guang Wang, San Jose, CA (US); Li Li Tay, San Jose, CA (US)

(21) Appl. No.: 16/004,414

(22) Filed: Jun. 10, 2018

Related U.S. Application Data
(60) Provisional application No. 62/517,997, filed on Jun. 12, 2017.

(51) Int. Cl. B25J 11/00; G06Q 30/06; G06Q 20/32; G06N 3/00

(52) U.S. Cl. CPC B25J 11/008; G06Q 30/0635; G06N 3/008; G06Q 20/3223; G06Q 30/0641

(57) ABSTRACT

A system and method herein described is for enabling artificial intelligence robot to provide services to individuals who send service request via handset or mobile device.

By means of Global Positioning System (GPS), remote control and program settings, artificial intelligence robot could make shopping at ease. This system accessible via the handset or mobile device is not just an autonomous shopping cart, it picks up items that are beyond shoppers' reach (examples: heavy items, items that are high up, items that are located far in distance). In addition, it saves the shoppers from standing in line to pay their shopping items at the cashier.

For regular shoppers, the system could learn the shopping pattern so specific needs could be catered to individual.

This application claims priority from U.S. Provisional Patent Application No. 62/517,997 filed on Jun. 12, 2017.

### FIELD OF THE INVENTION

System and method used for enabling artificial intelligence robot to provide services to individuals for making shopping at ease.

### DESCRIPTION

For many years customers shop in store with hand carrying the shopping items or using the shopping cart/basket. And when shopping is finished, customers get in line to wait for their turn to make payment. At checkout, all shopping items are to be brought out from the cart/basket to the counter prior to making the payment with cash or credit/debit card or others.

Over the past years, new systems/services are implemented however there's no breakthrough.

Here is a breakthrough business model to be presented. It involves the use of artificial intelligence robot for individuals or parties to shop in store and make shopping at ease.

Using handset or mobile device with Global Positioning System capability and associated application software downloaded, or store designed mobile device, customers are able to request services from artificial intelligence robot provided by the store.

Artificial intelligence robot can perform services not only limited to carrying, accompanying, checking out for customers but also other specific services designed by individual store depending on store location, place and situation.

With the use of artificial intelligence robot, it replaces the need of the following:

1. pushing/carrying the shopping cart/basket

2. picking of shopping items from shelve to shopping cart/basket

3. standing in line to wait for the turn to pay

4. removing of shopping items from cart/basket to checkout counter prior to making payment

It is man power reduction for the store.

More services could be offered other than those as above-mentioned like artificial intelligence robot could pick up heavy item or item that is beyond customer's reach (example: item that is placed high up on the shelve) or item that is located far in distance. Thus the use of artificial intelligence robot makes shopping at ease.

### BACKGROUND

Shopping with the use of shopping cart/basket and standing in line to wait for the turn to pay at the checkout counter bring inconvenience to the customers. In case of shopping item that is beyond shopper's reach, help from store associate is needed. When store gets busy, it is stressful not just for the store employees but the customers too.

### DETAILED DESCRIPTION

A system and method used by the store to provide breakthrough services for shoppers through the access of artificial intelligence robot via handset or mobile device with Global Positioning System capability, or store designed mobile device. Artificial intelligence robot is not just an autonomous shopping cart accompanying the shopper, the robot also picks up shopping items into its cart, checks out shopping items, and lastly returns to its preset home location for recharging or continues to the next assignment. Hereafter GPS for Global Positioning System in short will be written. Also artificial intelligence robot will be called Al robot. Al robot has built-in GPS chip and store designed control system. Customer(s) could access the robot simply by using handset or mobile device with associated application software downloaded. In case of unavailability, the store could provide store designed mobile device to customer(s).

1. Terms and conditions for use of Al robot are to be agreed and signed by shopper prior to use.

2. Customer(s) could access Al robot via handset or mobile device with GPS capability, or store designed mobile device to be provided by store. With associated software application downloaded, the accompanying, carrying, picking up and checking out of shopping items could be accomplished by requesting services from Al robot.

Hereafter handsets or mobile devices with GPS capability, or store designed mobile devices to be provided by store will be called mobile device.

3. Shopper is given a key code to activate Al robot. During shopping, Al robot maneuvers with shopper by trailing the signal from the mobile device. The built-in set of sensors prevent Al robot from bumping into obstacles and any moving objects that get in the way. Upon picking up shopping item, Al robot scans the bar code or magnetic strip then put the item into its cart. Al robot locks the cart so no item is removable once item is placed in cart and its scanned information is put in cart list. For item that is picked and scanned however it's not placed in cart, its scanned information will be discarded.

4. In case of items that are placed at a far distance, shopper has an option to enter the specific item(s) and its quantity for Al robot to pick up then Al robot would return to the shopper after pick-up.

5. When shopping is completed, shopper could view all items in cart list from Al robot's screen. Upon activating Al robot's voice, it reads out all items in cart list. In case there are any items that shopper decides to remove from cart list, Al robot would pick up the selected item(s) and put to trash list. Item(s) in trash list will be removed and separated from the wanted item(s).

6. When ready to pay, Al robot starts communicating with store processing center to send off scanned information in cart list for payment transaction to be processed next.

7. Al robot is installed with the capability for making payment via credit/debit card or mobile payment method (i.e. Wechat Pay, Alipay, digital wallet etc.) through scanning of QR (Quick Response) code or authorized code. This allows payment transaction to be done on Al robot. Upon successful payment transaction is completed, Al robot would send an acknowledgment to store processing center. In this case standing in line to wait for payment to be made is eliminated. For shoppers who prefer cash payment, it is made available at store payment kiosk.

8. Upon completion of payment, the dated receipt with shopping items, prices and payment information is sent to shopper via text message or email. Paper receipt if needed could be obtained from Al robot.

9. With payment done, Al robot unlocks its cart so shopping items can now be removed from Al Robot to end the shopping. Shopper(s) will return store designed mobile device if used to end the shopping.

10. When Al robot unlocks its cart, the assigned key code is deactivated to indicate the completion of accomplishment then it would start communicating with store processing center for direction if it should go to its home location for recharging or go to the customer service area to take on the assignment for the next shopper.

11. Al robot could offer service to accompany shopper to the designated loading area to unload shopping items from cart however this service has to be requested by customer via mobile device. Al robot sends request to store processing center so Al robot is allowed to go beyond the store exit to the designated loading area.

12. For regular customers, Al robot learns about their shopping pattern. As such specific needs could be catered for individuals therefore each could feel they are being treated as VIP (very important person) by the store.

Payment

1. Shopper(s) can make payment on Al robot using credit/debit card or mobile payment method (i.e. Wechat Pay, Alipay, digital wallet, Apple Watch etc.) through scanning of QR (Quick Response) code or authorized codes. This makes shopping at ease without the need to stand in line.

2. Cash payment methods like credit/debit card or cash payment are made available at store payment kiosk.

1. Al robot service business model, and computer-implemented system and method for arranging Al robot to provide services requested by customer(s) via handset or mobile device with GPS capability. Services to be provided by Al robot include accompanying and picking-up/carrying/securing/checking-out of item(s). The system enables:
(a) Customer to make service request using handset or mobile device.
(b) Communication with Al robot. The system provides Al robot the customer's geolocation information obtained from handset or mobile device with GPS capability.
(c) Al robot to trail signal from customer's handset or mobile device with GPS capability.
(d) Al robot to communicate with needed processor(s) through wireless network for payment to be made using mobile payment account associated with customer.

2. The system and method of claim 1, wherein includes configuring and programming customer's handset or mobile device to enable access of Al robot, for which the request of service is programming-generated from customer's handset or mobile device and communicated by one or more wireless networks to a corresponding system or device of Al robot.

3. The system and method of claim 1, further comprising the enabling customer's shopping information and identification to be programmatically exchanged between customer's handset/mobile device and corresponding system/device of Al robot.

4. The system and method of claim 1, wherein one or more processors are configured with interface to use wireless network system to transfer funds for payment from mobile payment account (i.e. Wechat Pay, Alipay, digital wallet etc) associated with the customer to a designated account associated with the store.

5. A computer-implemented method for processing data in regards to customer's shopping information so as to determine each individual's shopping pattern.

6. A system for processing data between Al robot and customer's mobile device so as the required operating service or lock/unlock of shopping item(s) or communication with store processing center for direction could be determined and set up.

7. A system and method enables shopper to enter the specific item(s) and its quantity for Al robot to pick up and return to the shopper after pick-up.

8. A system enables Al robot to
(a) maneuver with shopper by trailing the signal from the mobile device
(b) avoid bumping into obstacles and any moving objects that get in the way
(c) scan the bar code or magnetic strip
(d) secure item(s) placed in Al robot's cart and saved its scanned information
(e) discard scanned information for item that is picked and scanned however the scanned item is not placed in cart

9. A computer-implemented system and method that enables shopper to view all items in cart from Al robot's screen, activate Al robot's voice, remove unwanted item(s) from cart list and separate unwanted item(s) from cart.

10. A system enables Al robot to communicate with store processing center for obtaining information in regards to customer scanned item list for payment transaction to be processed next.

11. A computer-implemented method for processing data in regards to payment being made successfully so dated receipt with shopping items and prices and payment information could be set up and sent to shopper via text message or email.

12. A computer-implemented system and method for enabling Al robot to extend service for accompanying shopper to designated loading area to unload shopping items as requested by customer via handset/mobile device. When such request is made, Al robot sends it to store processing center so Al robot is allowed to go beyond the store exit to designated loading area.
